(19) United States
(12) Patent Application Publication
(10) Pub. No.: US 2014/0204211 A1
(43) Pub. Date: Jul. 24, 2014

(54) METHOD AND DEVICE FOR VEHICLE ACCESS CONTROL

(71) Applicant: Ford Global Technologies, LLC, Dearborn, MI (US)

(72) Inventors: Uwe GUSSEN, Huertgenwald (DE); Christoph ARNDT, Moerlen (DE); Frederic STEFAN, Aachen (DE)

(73) Assignee: Ford Global Technologies, LLC, Dearborn, MI (US)

(21) Appl. No.: 14/156,000

(22) Filed: Jan. 15, 2014

(30) Foreign Application Priority Data
Jan. 18, 2013 (DE) 10 2013 200 777.9

(51) Int. Cl. B60R 25/25

(52) U.S. Cl. CPC B60R 25/25
USPC 348/148

(57) ABSTRACT

A method and apparatus for controlling access to a motor vehicle using heartbeat rhythm patterns. An electronic camera installed in or on the vehicle images a skin surface of a person seeking access to the vehicle. A chronological change in coloration or swelling of the imaged skin surface indicates the person's heartbeat rhythm, and this rhythm is compared to stored reference data of authorized persons. The person is allowed access if the detected rhythm corresponds to the reference data. The allowed access to the vehicle may be the unlocking and/or opening of a door and or the starting of an engine. The method is initiated if the door latch is actuated, if a person is recognized in the vicinity of the vehicle, or if a near field communication occurs, for example, by means of capacitive sensors. The electronic camera is preferably a LIDAR camera.

### CROSS-REFERENCE TO RELATED APPLICATIONS

This application claims foreign priority benefits under 35 U.S.C. §119(l)-(d) to DE 10 2013 200 777.9 filed Jan. 18, 2013, and DE 10 2013 200 780.9 filed Jan. 18, 2013, which are hereby incorporated by reference in their entirety.

### TECHNICAL FIELD

The invention relates to a method and a device for identifying a person as a person authorized to drive a motor vehicle.

### BACKGROUND

Many systems for vehicle access control are known in the prior art. Instead of or in addition to classical mechanical ignition keys, electronic vehicle access control systems having transponders in electronic vehicle keys are currently frequently provided, i.e., keys without a mechanical engagement bit and instead with integrated digital electronics, using which the vehicle doors can be unlocked by remote control and the engine can be started. These systems recognize the person in possession of the electronic ignition key as a person authorized to enter or drive a motor vehicle. This also applies to card systems, for example, those which read a driver license card via radio frequency communication.

Also, secure vehicle access control systems are known which identify authorized persons on the basis of biometric features, for example on the basis of the retina or the fingerprint of a person seeking access.

DE 10 2005 020 847 A1 discloses a method for the contactless detection of biometric features of passengers in a motor vehicle, which can also be used to identify persons. For this purpose, an ultra-broadband radar having very short pulses is installed in a motor vehicle seat, which can detect the intrinsic movements of the chambers of the heart of the occupant. The person on the seat can be identified based on the characteristic signature of the heartbeat, because every human is known to have a unique heartbeat and heartbeat rhythm, which also remains identifiable in the event of mental or physical stress. Suitable electronically monitored vehicle seats are very complex, however.

http://www.technologyreview. com/news/425758/smart-phone-app-tracks-heart-rate/discloses that it is possible in principle by means of an electronic camera, here the camera of a smartphone, in front of which one holds a finger, to recognize minimal changes of the coloration of the skin of a person, which are caused by the pulsation of the blood flow, and to obtain a signature of the heartbeat therefrom. It is proposed therein that this be used to recognize a risk of heart failure, but not for any type of access controls.

The article http://www.farbimpulse.de/Herschlag-laesst-Gesichtsfarbe-pulsieren.herzschlag.0.html describes how, in addition to the chronological color change of the skin, the chronological swelling and subsiding of the skin because of the heartbeat can also be registered. Therefore, both the chronological change of the coloration and also the chronological swelling and subsiding of the skin and also the combination of the two are suitable as characteristics for registering the heartbeat signature.

### SUMMARY

According to a disclosed embodiment, a skin surface of a person seeking access to the motor vehicle is imaged by means of an electronic camera installed in the motor vehicle. It is ascertained how at least one characteristic of the imaged skin surface changes with respect to time. The chronological change of the characteristic of the imaged skin surface is compared to stored reference data of authorized persons. The person is allowed access to the motor vehicle if the chronological change of the characteristic of the imaged skin surface corresponds (at least to a predetermined degree) to the reference data.

A camera is much less complex than an ultra-broadband radar, and a camera suitable for the method is frequently already installed in current motor vehicles, so that the method is implementable only by additional software in the motor vehicle electronics.

Preferred characteristics of the imaged skin surface are the coloration and the swelling of the skin.

The coloration of the imaged skin surface is understood here as a continuous color spectrum or a discontinuous color spectrum, wherein the latter can also comprise only one wavelength or several wavelengths, since the heartbeat signature is possibly more easily recognizable in specific wavelength ranges than in others.

The allowed access to the vehicle may comprise the unlocking and/or opening of at least one door of the motor vehicle. In this case, the electronic camera registers a region outside the motor vehicle (near the door, for example) and a person seeking access to the motor vehicle is prompted to hold a bare body part in front of the camera. The allowed access can also comprise the starting of an engine of the motor vehicle.

The door unlocking/opening procedure can be carried out as known from the prior art for keyless access systems. The camera for the heartbeat recognition then turns on upon the presence of specific states of affair, for example, if the door latch is actuated, if a person is recognized in the vicinity of the vehicle, or if a near field communication occurs, for example, by means of capacitive sensors.

In one embodiment, the electronic camera is a camera provided for any type of driver assistance system and/or for vehicle cabin monitoring. The electronic camera is preferably a LIDAR camera, which is usable in the absence of ambient light.

If a person is identified as an authorized person, presets stored for the identified person, for example of seat positions, mirror position, temperature, radio transmitter, or the like, can be set in the motor vehicle.

### BRIEF DESCRIPTION OF THE DRAWINGS

Embodiments of the present invention described herein are recited with particularity in the appended claims. However, other features will become more apparent, and the embodiments may be best understood by referring to the following detailed description in conjunction with the accompanying drawings, in which:

FIG. 1 shows a schematic sketch of a system for identifying a person as a person authorized to drive a motor vehicle,

FIG. 2 shows a camera integrated in a side mirror for the system shown in FIG. 1,

FIG. 3 shows a motor vehicle front camera, which is arranged behind a windshield, for the system shown in FIG. 1,

FIG. 4 shows a camera, which is arranged behind a side window, for the system shown in FIG. 1, and

FIG. 5 shows a flowchart of a method for identifying a person as a person authorized to drive a motor vehicle.

### DETAILED DESCRIPTION

As required, detailed embodiments of the present invention are disclosed herein; however, it is to be understood that the disclosed embodiments are merely exemplary of the invention that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

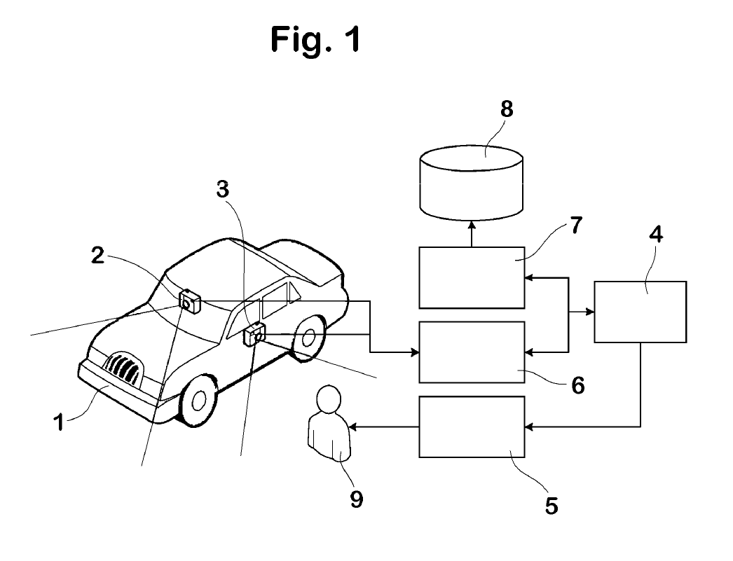

In FIG. 1, a motor vehicle 1 contains a front camera 2, which is oriented in the travel direction, and/or a side camera 3, which is oriented to the side. The cameras 2 or 3, respectively, can be cameras as are used for any type of driver assistance systems, thus, for example, a front camera 2, which is arranged behind a windshield, for a system for collision avoidance or a camera 3, which is arranged on one side of the motor vehicle 1, for a blind spot detection assistant. The cameras 2 or 3, respectively, can be CCD or LIDAR cameras, wherein the latter have the advantage of being usable independently of ambient light.

The motor vehicle 1 additionally contains onboard electronics, which contain a driver identification unit 4, a human-machine interface 5, a heartbeat extraction unit 6, a classification unit 7, and a data memory 8 for heartbeat reference patterns in the form of reference data.

The driver identification unit 4 may be, for example, a sequence control routine running in an onboard computer of the onboard electronics. It starts or is “woken up” when a person 9 approaches the motor vehicle 1. A desire of the person 9 to obtain access to the motor vehicle 1 can be transmitted to the motor vehicle 1 via radio or infrared signal, for example. Alternatively, it is also possible that an alarm system monitors the surroundings of the motor vehicle 1 and interprets specific behaviors or gestures of an approaching person 9 as an access desire.

If an access desire is recognized, the driver identification unit 4 prompts the person 9 by means of the human-machine interface 5, which can be simply a small flashing light, for example, to hold a visible body part, for example a finger, a hand, the face, or another segment of bare skin surface, for a specific time in front of the camera 2, 3 for imaging by the camera.

The image recorded during this time by the camera 2 or 3 is analyzed by the heartbeat extraction unit 6 to obtain heartbeat rhythm data of the person 9. The classification unit 7 puts the obtained heartbeat rhythm data into a format which permits a direct comparison to previously obtained reference data, which are stored in the data memory 8.

If the driver identification unit 4 establishes a sufficient correspondence between the heartbeat rhythm data of the person 9 and stored reference data, the vehicle doors are unlocked and the person 9 is permitted to start the motor vehicle 1 using, for example, a starting button. The successful identification can be acknowledged using a confirmation signal (audible and/or visible), so that the person 9 knows when he can remove his finger from the camera 2 or 3.

If the driver identification unit 4 does not establish a sufficient correspondence between the detected heartbeat rhythm data of the person 9 and stored reference data, any type of alarm can be triggered and/or a new access attempt can be permitted.

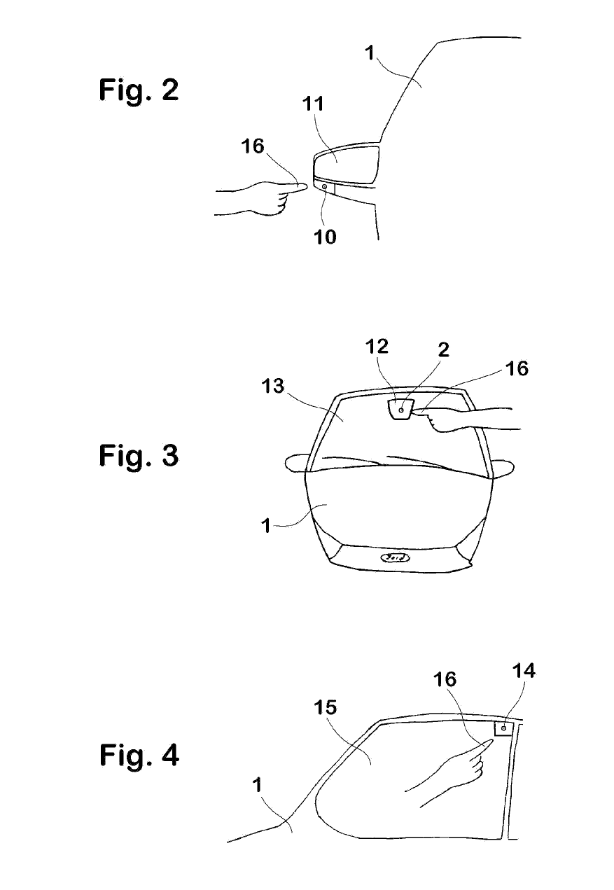

FIG. 2 shows a special example for the arrangement of a camera 10 intended for the vehicle identification system, specifically integrated in a side mirror 11 of the motor vehicle 1. Such cameras are often provided in parking assistants or blind spot recognition assistants.

FIG. 3 shows a special example for the arrangement of the camera 2 from FIG. 1, specifically in the region of a rearview mirror 12 behind a windshield 13 of the motor vehicle 1. Such a camera is currently used, for example, as a LIDAR front camera for collision avoidance at low speeds.

FIG. 4 shows a further special example for the arrangement of a camera 14, which is intended for the driver identification system, in a top right corner of a side window 15 of the driver door of the motor vehicle. This arrangement has the advantage of particularly good accessibility, and the camera 14 can also additionally be used for other purposes, for example for recognizing theft attempts, monitoring the traffic adjacent to the motor vehicle 1, etc.

In a further example (not shown in the drawings), a camera also provided for vehicle cabin monitoring, which has the person seated on the driver's seat in the field of vision, is used as a camera of the driver identification system. By means of such a camera, of course, the unlocking of the doors cannot be controlled, however, the driving per se can be prevented if the person seated on the driver's seat is not recognized as an authorized person, and in addition presets stored for authorized persons can be applied to the motor vehicle 1. Such a camera has the advantage that the identification does not have to be waited for outside the vehicle, and in addition it may rather be possible in this case to obtain heartbeat rhythm data from the facial color of the person seated on the driver's seat, so that he does not have to be active in any way.

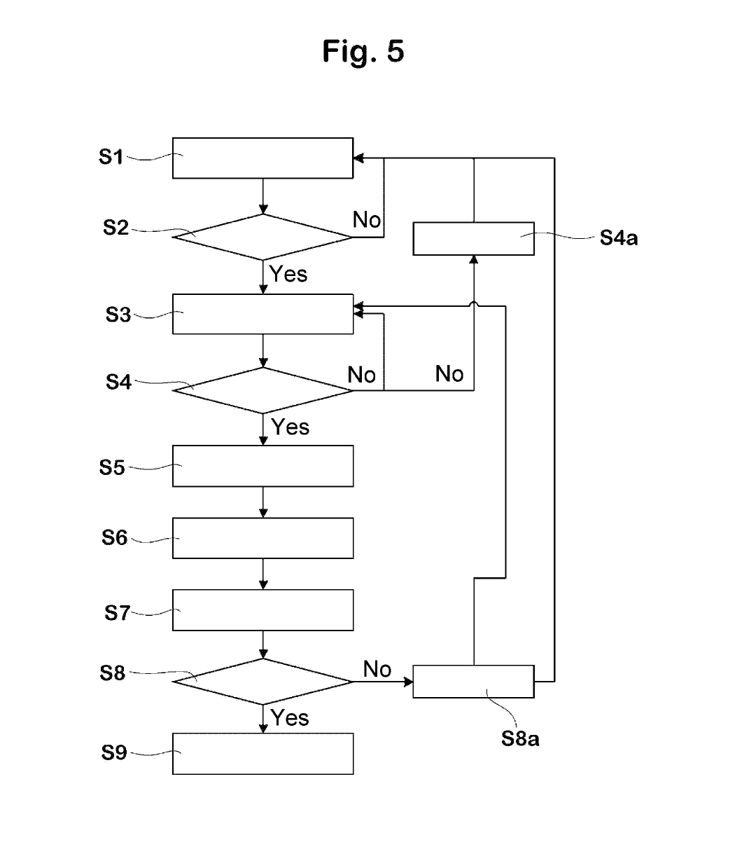

A camera as described with reference to FIGS. 1 to 4 images the finger 16 held in front of it of a person 9; the chronological change of the coloration and/or swelling of the imaged skin surface is compared to the stored reference data of authorized persons; and access is allowed to the motor vehicle 1 if the chronological change(s) in the imaged skin surface corresponds to the reference data, at least to a predetermined degree. This will be described in greater detail with reference to FIG. 5.

In step S1 of the flowchart of FIG. 5, the driver identification system waits for a request for access to the motor vehicle 1. This waiting state is entered every time a driver leaves and locks the motor vehicle 1.

In step S2, it is checked whether a person 9 approaches the motor vehicle 1 and/or signals an access desire, for example by means of an electronic vehicle key, a smartphone, or the like. If this is the case, the driver identification system is activated; otherwise, it goes back to step S1.

In step S3, the activated driver identification system prompts the person 9 to hold one or more fingers in front of a camera 2, 3, 10, or 14 (FIGS. 1 to 4). The position where the fingers are to be held can be indicated to the person 9 by a tone signal or by an LED flashing light having a specific color and/or flashing frequency, which is generated close to the camera, and/or a corresponding message can be sent to the smartphone of a person 9 registered as access-authorized.

In step S4, it is checked whether the person 9 holds his finger in front of the camera. If this is not the case, step S3 is repeated, and if this is repeatedly not the case, for example the person 9 does not react or changes his intention, a time lock is activated in step S4a, in which the driver identification system does not respond, and after passage of the time lock, it goes back to step S1.

If it is confirmed in step S4 that the person 9 holds his finger in front of the camera, the finger is imaged in step S5 for at least a few heartbeats long, and heartbeat rhythm data of the person 9 are obtained from this image.

In step S6, the obtained heartbeat rhythm data are brought into a format which permits a direct comparison to stored reference data of persons 9 registered as access-authorized. This comparison occurs in step S7. The reference data can be obtained or changed in any type of secure registration process.

If it is confirmed in step S8 that the heartbeat rhythm data obtained from the person 9 correspond to stored reference data or correspond thereto at least to a predetermined degree, the person 9 is successfully identified as access-authorized, and in step S9, the motor vehicle 1 is unlocked and the person 9 is permitted to start the motor vehicle 1. In addition, presets stored for the identified person 9 can be applied to the motor vehicle, for example seat positions, mirror position, temperature in the vehicle interior, radio transmitter, and the like. The method ends with step S9, in that it returns to step S1.

If the heartbeat rhythm data obtained from the person 9 do not correspond to stored reference data, the person 9 is not successfully identified as access-authorized, and in step S8a, the person 9 is informed, for example by a tone signal or LED flashing light or a radio message to the smartphone of a person 9 registered as access-authorized, about the failed identification, and it returns to step S3. In the case of repeated identification failures, the method returns to step S1, and in this case it can be provided that motor vehicle 1 establishes a data connection to an operator in a central office to clarify the situation. The person 9 is possibly not correctly registered in the databank of access-authorized users of the motor vehicle 1. There is possibly also a problem with the camera, for example dirt in front of the camera objective, which impairs the vision of the camera, too little battery voltage, and the like. In such a case, the person 9 could be identified by the operator as access-authorized, for example by means of a smartphone, and in this case the operator is to have the possibility of unlocking the motor vehicle 1 remotely.

The disclosed method may be combined with a so-called MyKey® System. This is a system for the automatic restriction or forced activation of specific functions of a motor vehicle as a function of identity-related data, which are uniquely assigned to a personal electronic vehicle key, which its possessor shows in relation to the vehicle electronics as a driver authorized to drive the motor vehicle. This personal vehicle key is individually programmable, so that the motor vehicle is operable using this key only in a restricted driving mode. The highest speed, the vehicle acceleration, and/or the volume of the stereo system can thus be restricted to preset maximum values, or specific vehicle safety systems or driver assistance systems are or become permanently activated, for example seatbelt fastening warning, lane maintaining assistant, or adaptive cruise control. This system is intended for specific persons, primarily novice drivers, to which the electronic vehicle key is handed out.

In combination with the MyKey® System, the disclosed application of presets to the motor vehicle comprises an automatic restriction or forced activation of specific functions of the motor vehicle as a function of identity-related data, which are uniquely assigned to a personal electronic vehicle key, which its possessor shows in relation to the vehicle electronics as a driver authorized to drive the motor vehicle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for identifying a person as being authorized to drive a motor vehicle, comprising:
imaging a skin surface of a person seeking access to the motor vehicle using an electronic camera installed in the motor vehicle;
detecting a chronological change in a characteristic of the imaged skin surface;
comparing the chronological change of the characteristic of the imaged skin surface to stored reference data; and
allowing access to the motor vehicle if the chronological change of the characteristic of the imaged skin surface corresponds at least to a predetermined degree to the reference data.

2. The method of claim 1, wherein the characteristic of the imaged skin surface is at least one of coloration of the skin and swelling of the skin.

3. The method of claim 1, further comprising prompting the person seeking access to the motor vehicle to present the skin surface to the camera.

4. The method of claim 1, wherein the allowed access comprises at least one of unlocking and opening of a door of the motor vehicle.

5. The method of claim 1, wherein the allowed access comprises starting of an engine of the motor vehicle.

6. The method of claim 1, wherein the electronic camera is utilized with at least one of a driver assistance system and a vehicle cabin monitoring system.

7. The method of claim 1, wherein the electronic camera is a LIDAR camera.

8. The method of claim 1, further comprising applying a vehicle system preset for the person identified as being authorized to drive the motor vehicle.

9. The method of claim 8, wherein the application of the preset comprises at least one of an automatic restriction and an automatic activation of the vehicle system as a function of identity-related data assigned to an electronic vehicle key.

10. Apparatus for controlling access to a motor vehicle, comprising:
an electronic camera on the vehicle imaging a skin surface of a person seeking access to the vehicle;
a data memory containing reference data of an access-authorized person; and
a driver identification unit comparing a heartbeat rhythm obtained from inputs from the electronic camera with the reference data, and allowing access if a correspondence exists.

11. The apparatus of claim 10, further comprising a heartbeat extraction unit obtaining the heartbeat rhythm from the image by analyzing a chronological change in at least one of a coloration of the imaged skin surface and a swelling of the imaged skin surface.

12. The apparatus of claim 10, wherein the driver identification unit determines that the person desired access to the vehicle based upon at least one of a radio signal and an infrared signal received from the person.

13. The apparatus of claim 10, further comprising:
a human-machine interface generating a signal prompting the person to position the skin surface for imaging by the camera.

14. The apparatus of claim 10, wherein the electronic camera is interfaced with at least one of a driver assistance system and a cabin monitoring system.

15. The apparatus of claim 10, wherein the electronic camera is a LIDAR camera.

16. The apparatus of claim 10, wherein the driver identification unit further applies a vehicle system preset for the person seeking access if the person is identified as being authorized to drive the motor vehicle.

17. The apparatus of claim 16, wherein the preset comprises at least one of an automatic restriction and an automatic restriction and an automatic activation of the vehicle system as a function of identity-related data assigned to an electronic vehicle key.

18. A method for controlling access to a motor vehicle, comprising:
operating an electronic camera to image a skin surface of a person seeking access to the vehicle;
determining a heartbeat rhythm of the person from a chronological change in the imaged skin surface;
comparing the heartbeat rhythm with stored reference data; and
allowing access to the motor vehicle if the heartbeat rhythm corresponds to the reference data.

19. The method of claim 18, wherein the chronological change of the imaged skin surface is at least one of a change in coloration and a change in swelling.

20. The method of claim 18, wherein the allowed access comprises at least one of unlocking and opening of a door of the motor vehicle.
